(19) United States
(12) Patent Application Publication
(10) Pub. No.: US 2024/0090371 A1
(43) Pub. Date: Mar. 21, 2024

(54) HIGH EFFICIENCY MOW DECK AND MULTI-BLADE CUTTING SYSTEM FOR RIDE-ON MAINTENANCE APPARATUS

(71) Applicant: MTD PRODUCTS INC, Valley City, OH (US)

(72) Inventors: Theodore Nichols, Middleburg Heights, OH (US); Christian Emhoff, Medina, OH (US); Heath Rohrbaugh, Medina, OH (US)

(21) Appl. No.: 18/370,236

(22) Filed: Sep. 19, 2023

Related U.S. Application Data
(60) Provisional application No. 63/408,308, filed on Sep. 20, 2022.

(51) Int. Cl. A01D 34/66; A01D 34/73; A01D 34/78; A01D 34/81

(52) U.S. Cl. CPC A01D 34/66; A01D 34/733; A01D 34/78; A01D 34/81

(57) ABSTRACT

A high efficiency mow deck and cutting system for a lawn maintenance apparatus is discussed. One example embodiment comprises a lawn maintenance apparatus, comprising: a frame; a plurality of drive wheels rotatable about a drive wheel rotation axis; at least one of an operator seat or a standing platform secured to the frame; operator controls for operator-initiated functions of the lawn maintenance apparatus; and a mow deck secured to the frame, wherein the mow deck comprises a plurality of mow spindles, wherein each mow spindle of the plurality of mow spindles is configured to drive one or more mow blades, and wherein the mow deck comprises at least one baffle that reduces space around the one or more mow blades of at least one of the plurality of mow spindles.

### CROSS-REFERENCE TO RELATED APPLICATIONS

This application claims the benefit of U.S. Provisional Patent Application 63/408,308 filed Sep. 20, 2022, the entirety of which is hereby incorporated by reference within the present disclosure in its entirety and for all purposes. The following are hereby incorporated by reference within the present disclosure in their respective entireties and for all purposes: U.S. patent application Ser. No. 16/782,409 filed Feb. 5, 2020, U.S. patent application Ser. No. 17/693,727 filed Mar. 14, 2022, U.S. Provisional Application No. 62/907,992 filed Sep. 30, 2019, U.S. Provisional Application No. 62/801,202 filed Feb. 5, 2019, U.S. Provisional Application No. 63/160,524 filed Mar. 12, 2021, U.S. Provisional Application No. 63/213,646 filed Jun. 22, 2021, and U.S. Provisional Application No. 63/408,308 filed Sep. 20, 2022.

### FIELD OF DISCLOSURE

The disclosed subject matter pertains to apparatuses and methods for lawn maintenance devices having a high efficiency mow deck and/or cutting system as discussed herein, and to such lawn maintenance apparatuses.

### BACKGROUND

Manufacturers of power equipment for outdoor maintenance applications offer many types of machines for general maintenance and mowing applications. Generally, these machines can have a variety of forms depending on application, from general urban or suburban lawn maintenance, rural farm and field maintenance, to specialty applications. Even specialty applications can vary significantly. For example, mowing machines suitable for sporting events requiring moderately precise turf, such as soccer fields or baseball outfields may not be suitable for events requiring very high-precision surfaces such as golf course greens, tennis courts and the like.

Lawn maintenance equipment can employ a variety of blades and/or mow decks, some of which are specialized for a variety of purposes. As one example, different blades and/or mow decks can be employed for mulching (e.g., where smaller grass clippings can be desirable, etc.) than for bagging of grass. In some scenarios, the same mow deck can be reused for multiple purposes, such as by the addition or removal of a mulch kit and/or changing of blades for specific applications. In general, the longer grass clippings are recirculated by a cutting system, the more power is expended by the lawn maintenance equipment. While this may be intentional in some systems and scenarios (e.g., mulching, etc.), repeated circulation of grass clippings in a mowing chamber can be inefficient and can increase power consumption.

### BRIEF SUMMARY

The following presents a simplified summary in order to provide a basic understanding of some aspects of the disclosure. This summary is not an extensive overview of the disclosure. It is not intended to identify key/critical elements or to delineate the scope of the disclosure. Its sole purpose is to present some concepts of the disclosure in a simplified form as a prelude to the more detailed description that is presented later.

Various embodiments of the present disclosure include high efficiency mow decks and cutting systems, as well as lawn maintenance apparatuses comprising the same. One example embodiment comprises a lawn maintenance apparatus, comprising: a frame; a plurality of drive wheels rotatable about a drive wheel rotation axis; at least one of an operator seat or a standing platform secured to the frame; operator controls for operator-initiated functions of the lawn maintenance apparatus; and a mow deck secured to the frame, wherein the mow deck comprises a plurality of mow spindles, wherein each mow spindle of the plurality of mow spindles is configured to drive one or more mow blades, wherein the mow deck comprises at least one baffle that reduces space around the one or more mow blades of at least one of the plurality of mow spindles, and wherein the at least one baffle comprises a W-baffle with a non-vertical cross-section that comprises an associated arc for each mow spindle of the plurality of mow spindles, wherein on each associated arc the W-baffle is a substantially constant distance from an axis of rotation of the mow spindle of that associated arc on a plane of the one or more mow blades of that spindle.

A second example embodiment comprises a lawn maintenance apparatus, comprising: a frame; a plurality of drive wheels rotatable about a drive wheel rotation axis; at least one of an operator seat or a standing platform secured to the frame; operator controls for operator-initiated functions of the lawn maintenance apparatus; and a mow deck secured to the frame, wherein the mow deck comprises a plurality of mow spindles, wherein each mow spindle of the plurality of mow spindles is configured to drive two associated mow blades comprising four equally spaced associated blade tips.

A third example embodiment comprises a mow deck for a lawn maintenance apparatus, comprising: a bottom portion formed from a first single stamped sheet of material, wherein the bottom portion comprises a first plurality of spindle holes, wherein each spindle hole of the first plurality of spindle holes is shaped to accommodate an associated mow spindle of a plurality of mow spindles, wherein the bottom portion comprises at least one baffle configured to reduce space around one or more mow blades of the plurality of mow spindles; and a top portion formed from a second single stamped sheet of material, wherein the top portion comprises a second plurality of spindle holes configured to align with the first plurality of spindle holes, wherein each spindle hole of the second plurality of spindle holes is shaped to accommodate an associated mow spindle of the plurality of mow spindles, wherein the top portion comprises one or more embossed regions that are raised relative to one or more unembossed regions of the top portion, and wherein the one or more embossed regions of the top portion act as stiffening features to at least one of prevent or mitigate deformation of the mow deck.

A fourth example embodiment comprises a method of fabricating a mow deck for a lawn maintenance apparatus, comprising: stamping a first single sheet of material to form a bottom portion of the mow deck, wherein the bottom portion comprises at least one baffle configured to reduce space around one or more mow blades of the plurality of mow spindles; cutting a first plurality of holes in the bottom portion, wherein the first plurality of holes comprises a first plurality of spindle holes, wherein each spindle hole of the first plurality of spindle holes is shaped to accommodate an associated mow spindle of a plurality of mow spindles, stamping a second single sheet of material to form a top portion of the mow deck, wherein the top portion comprises one or more embossed regions that are raised relative to one or more unembossed regions of the top portion, and wherein the one or more embossed regions of the top portion act as stiffening features to at least one of prevent or mitigate deformation of the mow deck; cutting a second plurality of holes in the top portion, wherein the second plurality of holes comprises a second plurality of spindle holes configured to align with the first plurality of spindle holes, wherein each spindle hole of the second plurality of spindle holes is shaped to accommodate an associated mow spindle of the plurality of mow spindles; and welding the top portion to the bottom portion at a plurality of welding locations.

To accomplish the foregoing and related ends, certain illustrative aspects of the disclosure are described herein in connection with the following description and the drawings. These aspects are indicative, however, of but a few of the various ways in which the principles of the disclosure can be employed and the subject disclosure is intended to include all such aspects and their equivalents. Other advantages and features of the disclosure will become apparent from the following detailed description of the disclosure when considered in conjunction with the drawings.

### BRIEF DESCRIPTION OF THE DRAWINGS

FIG. 1 illustrates a top perspective view of an example mow deck according to various embodiments discussed herein.

FIG. 1A illustrates images of a top plate, a bottom plate, and a mow deck formed from the top plate and the bottom plate, according to various aspects discussed herein.

FIG. 2 illustrates a bottom perspective view of an example mow deck, according to various embodiments discussed herein.

FIG. 3 illustrates a bottom perspective view (top image) and a side view (bottom image) of an assembled embodiment of an example mow deck with mow spindles, mow blades, and wheels, according to various embodiments discussed herein.

FIG. 4 illustrates an example pair of blade tips formed on a mow blade made from a single piece of metal strip stock, according to various embodiments discussed herein.

FIG. 5 illustrates a bottom perspective view and a side view of a mow deck employing teardrop shaped spindle baffles around mow spindles, according to various embodiments discussed herein.

FIG. 6 illustrates a front diagram (top image) and a bottom diagram (bottom image) of an example embodiment of a mow deck, according to various embodiments discussed herein.

FIG. 7 illustrates a first front diagram (top), bottom diagram (middle), and second front diagram (bottom) of an example embodiment of a mow deck, according to various embodiments discussed herein.

FIG. 8 illustrates an example embodiment of a mulching mow deck, according to various aspects discussed herein.

FIG. 9 illustrates a bottom view (top image) and a side cross-section view (bottom image) of an example mow deck with tapered spindle cups or baffles, according to various embodiments discussed herein.

FIG. 10 illustrates a bottom view and a side perspective view of an example mow deck comprising teardrop spindle baffles, according to various embodiments discussed herein.

FIG. 11 illustrates left perspective (top) and right (bottom) views of an example embodiment of a lawn maintenance apparatus in a seated configuration, according to various aspects discussed herein.

FIG. 12 illustrates top (top) and front (bottom) views of the example embodiment in the seated configuration, according to various aspects discussed herein.

FIG. 13 illustrates rear (top) and left (bottom) views of the example embodiment in the seated configuration, according to various aspects discussed herein.

FIG. 14 illustrates left perspective (top) and right (bottom) views of the example embodiment in a standing configuration, according to various aspects discussed herein.

FIG. 15 illustrates top (top) and front (bottom) views of the example embodiment in the standing configuration, according to various aspects discussed herein.

FIG. 16 illustrates rear (top) and left (bottom) views of the example embodiment in the standing configuration, according to various aspects discussed herein.

It should be noted that the drawings are diagrammatic and not drawn to scale. Relative dimensions and proportions of parts of the figures have been shown exaggerated or reduced in size for the sake of clarity and convenience in the drawings. The same reference numbers are generally used to refer to corresponding or similar features in the different embodiments, except where clear from context that same reference numbers refer to disparate features. Accordingly, the drawings and description are to be regarded as illustrative in nature and not as restrictive.

### DETAILED DESCRIPTION

The following terms are used throughout the description, the definitions of which are provided herein to assist in understanding various aspects of the subject disclosure.

As used in this application, the terms “outdoor power equipment”, “outdoor power equipment machine”, “power equipment”, “maintenance machine” and “power equipment machine” are used interchangeably and are intended to refer to any of robotic, partially robotic ride-on, walk-behind, sulky equipped, autonomous, semi-autonomous (e.g., user-assisted automation), remote control, or multi-function variants of any of the following: powered carts and wheel barrows, lawn mowers, lawn and garden tractors, lawn trimmers, lawn edgers, lawn and leaf blowers or sweepers, hedge trimmers, pruners, loppers, chainsaws, rakes, pole saws, tillers, cultivators, aerators, log splitters, post hole diggers, trenchers, stump grinders, snow throwers (or any other snow or ice cleaning or clearing implements), lawn, wood and leaf shredders and chippers, lawn and/or leaf vacuums, pressure washers, lawn equipment, garden equipment, driveway sprayers and spreaders, and sports field marking equipment.

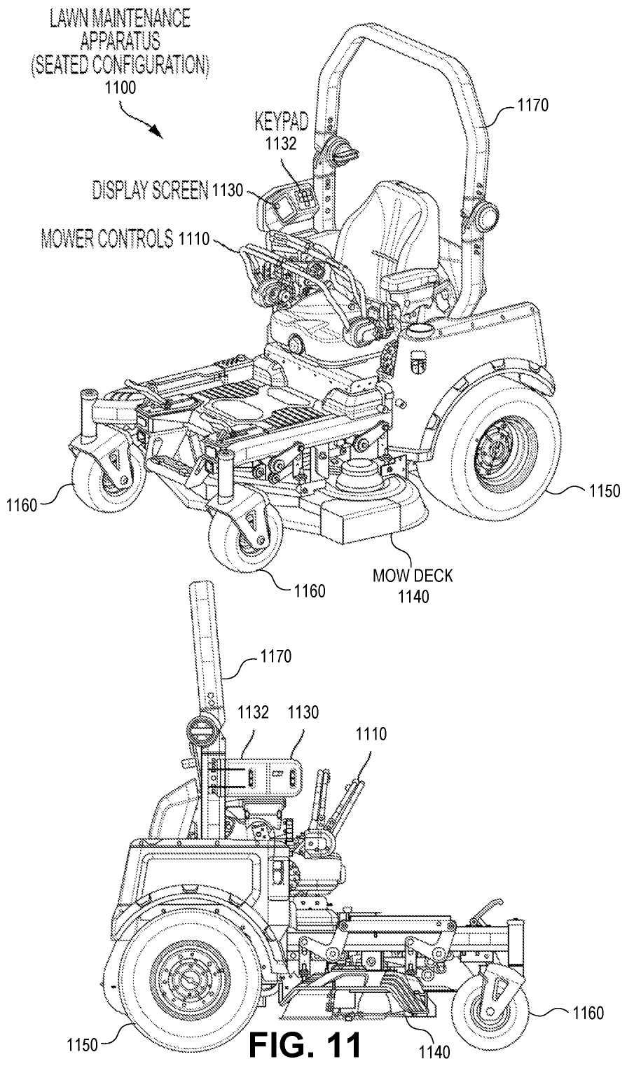

Various embodiments can comprise a lawn maintenance apparatus comprising a high efficiency mow deck and cutting system according to various aspects discussed herein and/or such a high efficiency mow deck and cutting system (example embodiments can provide for power reduction of approximately 30-50% compared to other mow decks, etc.). A lawn maintenance apparatus according to aspects discussed herein can be a ride-on lawn maintenance apparatus of any of a variety of configurations, such as a seated lawn maintenance apparatus, a standing lawn maintenance apparatus, or a convertible seated/standing lawn-maintenance apparatus, such as the example lawn maintenance apparatuses described in connection with FIGS. 11-16 below.

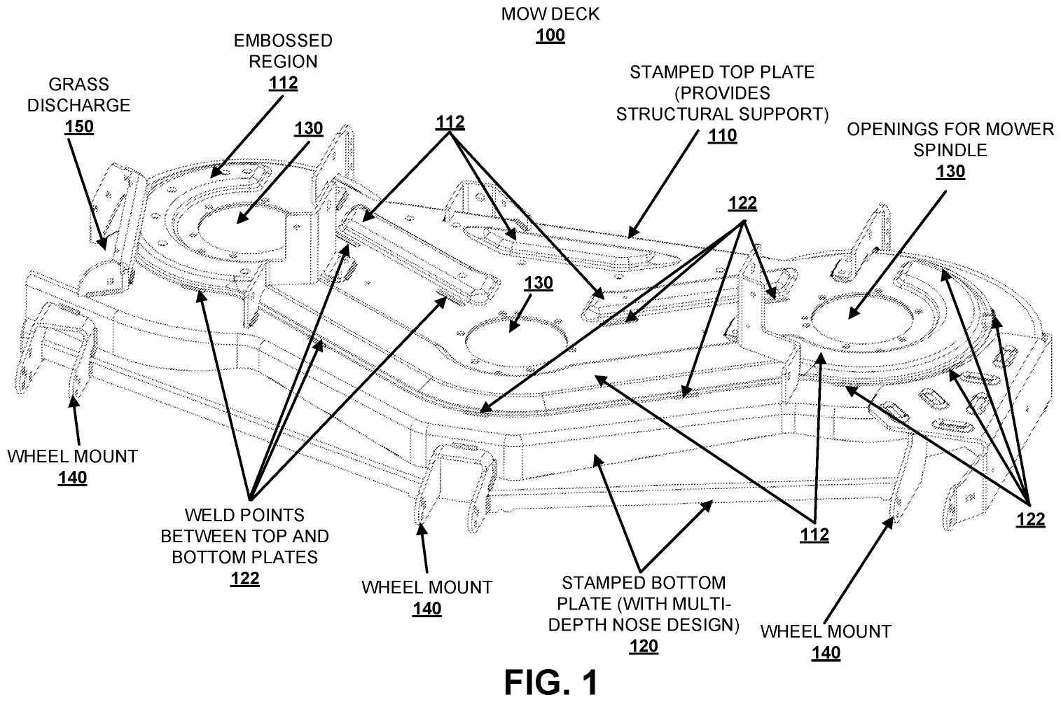

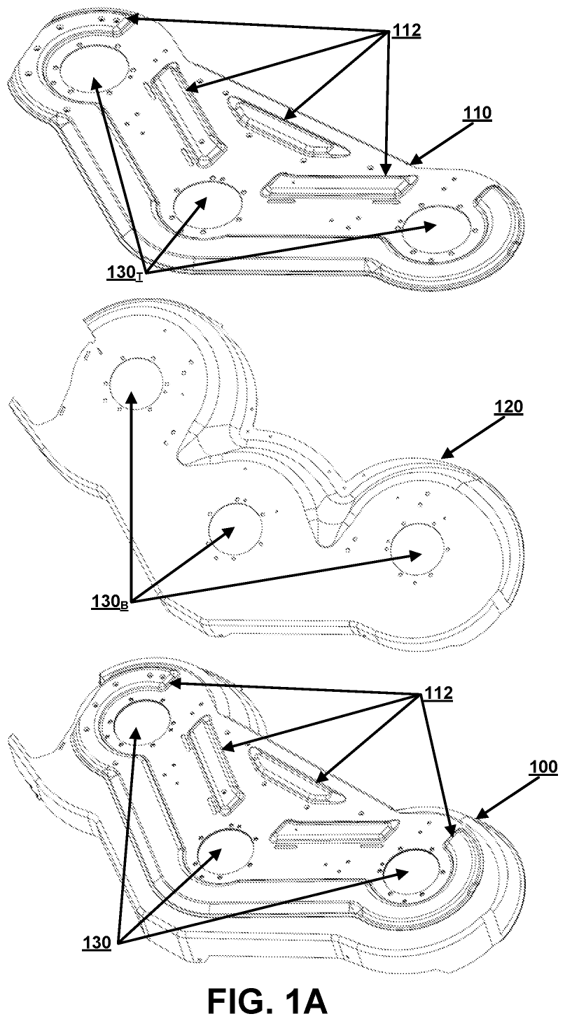

Referring to FIG. 1, illustrated is a top perspective view of an example mow deck 100 according to various embodiments discussed herein. Mow deck 100 can comprise a top plate 110 (e.g., stamped and cut from a first single sheet of material), which can be welded to a bottom plate 120 (e.g., stamped and cut from a second single sheet of material). Top plate 110 can comprise one or more embossed regions 112 that are raised above one or more unembossed regions, and the embossed regions 112 can provide stiffening and structural support for mow deck 100 to resist or mitigate deformation of mow deck 100, without the necessity of welding additional stiffening features to mow deck 100 (the unlabeled vertically oriented pieces welded to top plate 110 shown in FIG. 1 are connections for raising and lowering mow deck 100).

Referring to FIG. 1A, illustrated are images of top plate 110, bottom plate 120, and mow deck 100 formed from top plate 110 and bottom plate 120, according to various aspects discussed herein. Top plate 110 can be formed by stamping a first sheet of material (e.g., steel, etc.), followed by cutting (e.g., with a 3D laser, etc.) the stamped first sheet of material to create a plurality of openings, such as openings 130T for mow spindles, openings for accessory mounting, for weld points 122, etc. Bottom plate 120 can be formed by stamping a second sheet of material (e.g., steel, etc.), followed by cutting (e.g., with a 3D laser, etc.) the stamped second sheet of material to create a plurality of openings, such as openings 130B for mow spindles, openings for fasteners, etc.

Top plate 110 can also be employed for mounting attachments, such as a side bagger, power assist bagger, etc. Attachments can be mounted to top plate 110 at openings in top plate 110 without corresponding openings in bottom plate 120, attachments can be mounted to mow deck 100 without being mounted into the top of the cutting chamber (which is defined by bottom plate 120), unlike existing mow decks. Additionally, form was added to top plate 110 to function as drainage holes for E-coat (electrophoretic painting) and/or paint.

Top plate 110 can be welded to bottom plate 120 at a plurality of weld locations or weld points 122, which can include one or more weld points 122 around an outer edge of top deck 110 and/or one or more weld points 122 through openings in the surface of top plate 110 (e.g., near the two straight angled embossed features 112 shown in FIG. 1). Openings 130_{T} in top plate 110 and openings 130_{B} in bottom plate 120 can be aligned to form three openings 130 for mower spindles, which can be arranged into a shallow V or obtuse triangle, with the center mower spindle closer to the front of mow deck 100 (and any lawn maintenance apparatus comprising mow deck 100) than the two outside spindles.

Various embodiments of mow deck 100 (e.g., and other mow decks according to various aspects discussed herein, etc.) can have a variety of front nose designs (e.g., see FIGS. 1-7, etc.). Various nose designs can employ a multi-depth nose design 120, which can comprise multiple heights of front baffles (e.g., to prevent objects entering under the mow deck 100 and/or control air flow within the mow deck 100, etc.).

Mow deck 100 can also comprise a plurality of wheel mounts 140 to house wheels that can provide additional support for mow deck 100 when mounted on a lawn maintenance apparatus, as well as providing for anti-turfing and preventing the mow blades from impacting the ground.

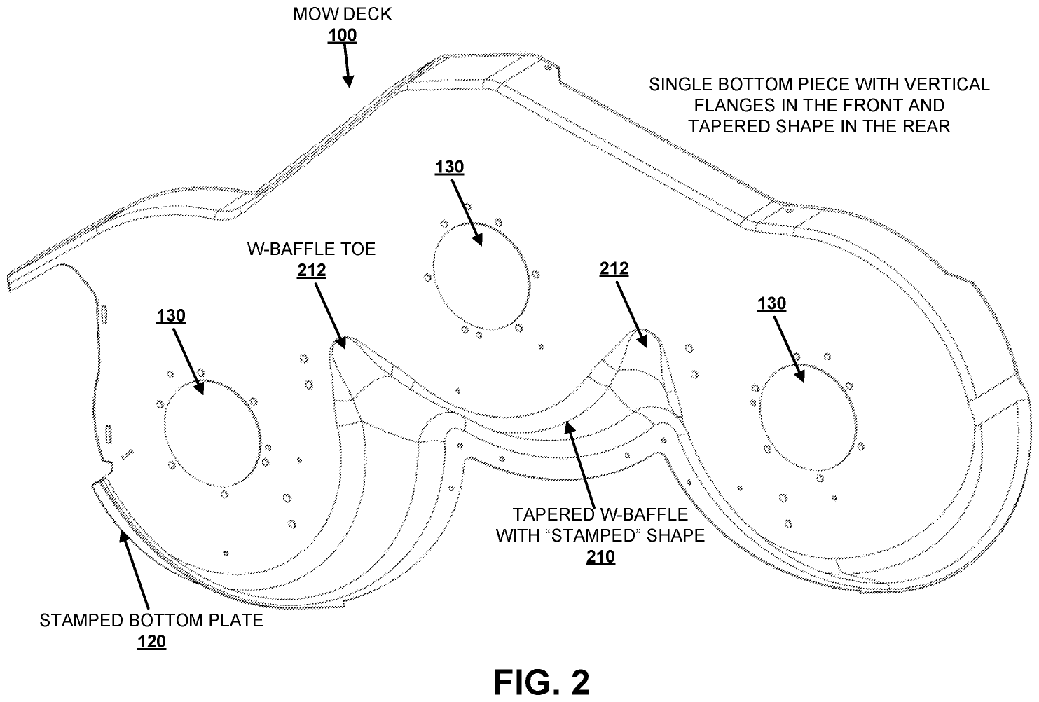

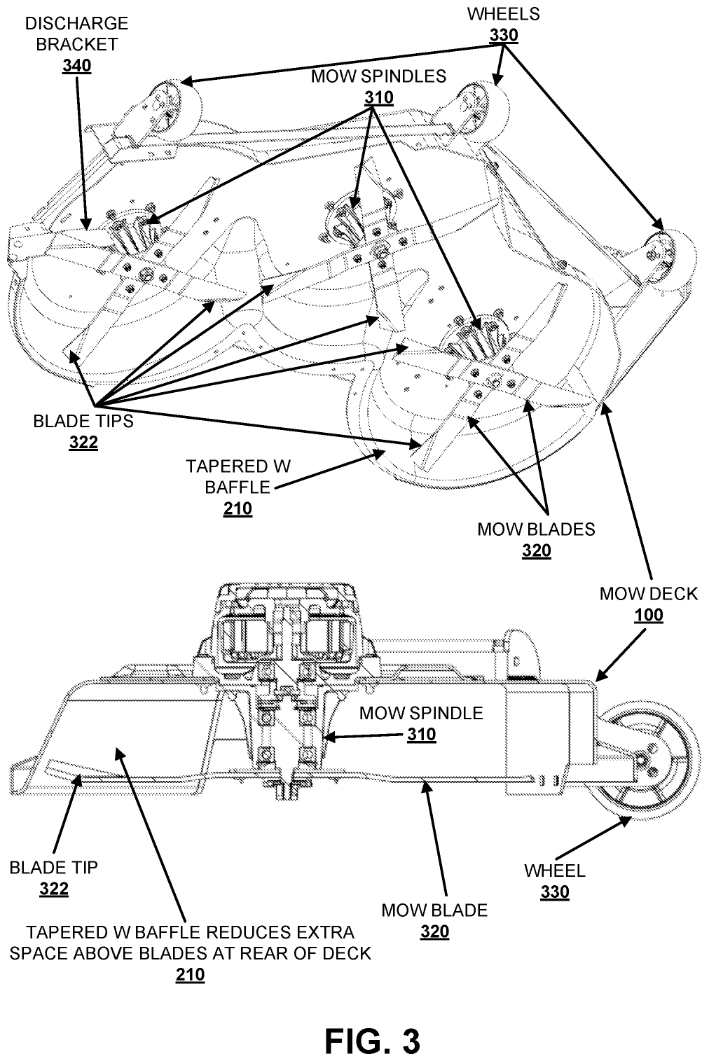

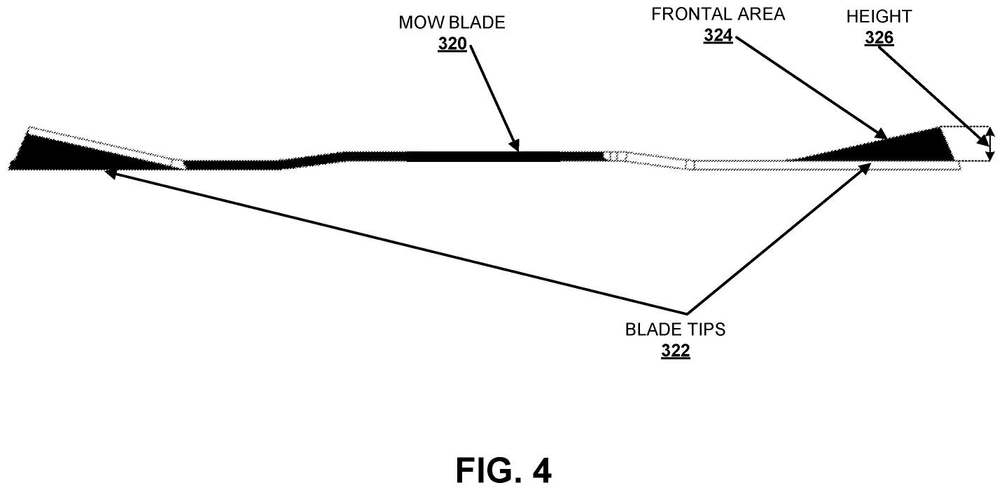

Referring to FIG. 2, illustrated is a bottom perspective view of the example mow deck 100, according to various embodiments discussed herein. Mow deck 100 (e.g., and other mow decks discussed herein, etc.) can comprise a tapered W-baffle 210. W-baffle 210 can have a curved stamped shape that can track the outer edges of the radii of mow blades (not shown in FIG. 2, but see FIGS. 3 and 4) that are mounted on mower spindles through each of the openings 130 (e.g., maintaining a substantially constant distance from each radius over an arc), while allowing a gap between the radii and the W-baffle 210 on the plane of rotation of the mow blades. A horizontal cross-section of W-baffle 210 can comprise a plurality of arcs, wherein on each arc, each point on that arc has the same radial distance from the center of an associated mow spindle (or opening 130 for a mow spindle). Adjacent arcs can meet at W-baffle toes which curve in the opposite direction, and can have a relatively small radius (e.g., 2-2.5″, 1.5-3″, etc.) that can depend on the size of mow deck 100 (e.g., one example 48″ embodiment and one example 54″ embodiment have an approximately 2.125″ radius for W-baffle toes 212, while one example 60″ embodiment has a 2.375″ radius for W-baffle toes 212, etc.). A vertical cross-section of W-baffle 210 can have a curved shape, curving inward (e.g., toward openings 130 and/or the front of mow deck 100) toward the top of W-baffle 210 (e.g., above the plane of rotation of mow blades) and outward (e.g., away from openings 130 and/or the front of mow deck 100) toward the bottom of W-baffle 210 (e.g., below the plane of rotation of mow blades). W-baffle 210 can reduce the space within the mow deck 100, reducing extra space above mow blades at the rear of mow deck 100, thereby improving air flow and efficiency of mow deck 100. Additionally, the shape of W-baffle 210 (e.g., closer to the mow spindles at the top and further from the mow spindles at the bottom) can direct at least a portion of air and grass clippings downward and outward along the surface of W-baffle 210, and thus out from under mow deck 100, saving energy that would otherwise be spent recirculating those clippings. As can be seen in FIG. 2, the front of mow deck 100 can comprise one or more substantially vertical front baffles, which can be closer to mow spindles further from a grass discharge 150 of mow deck 100 and further from mow spindles closer to grass discharge 150.

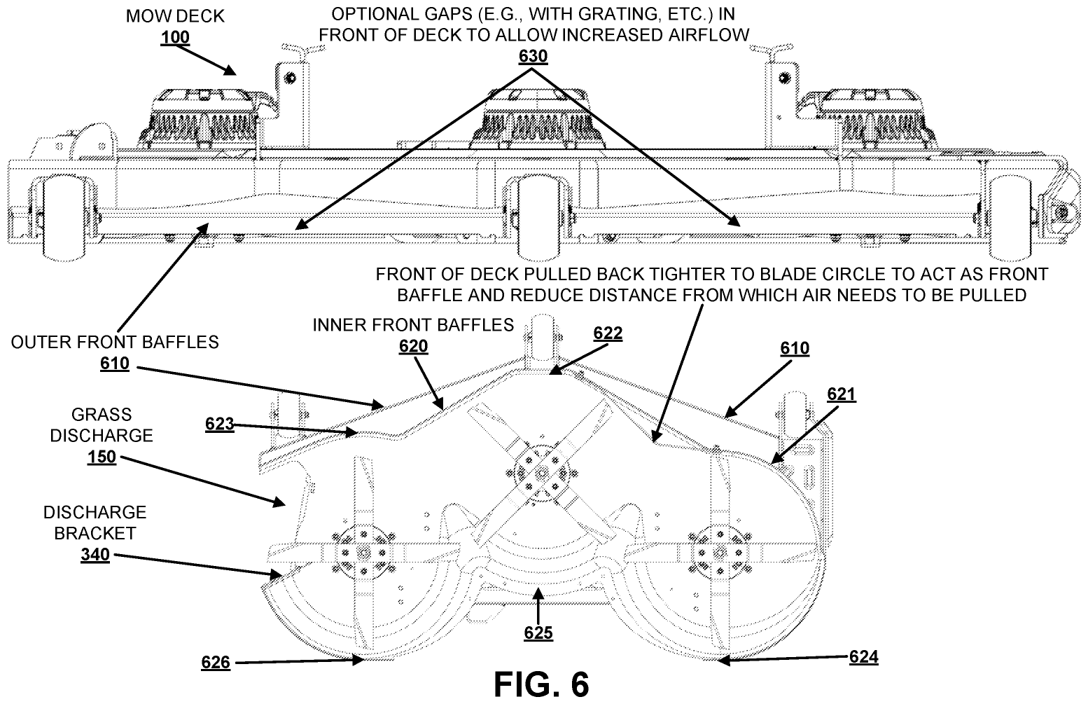

Referring to FIG. 3, illustrated are a bottom perspective view (top image) and a side cross-section view (bottom image) of an assembled embodiment of mow deck 100 with mow spindles 310, mow blades 320, and wheels 330, according to various embodiments discussed herein. FIG. 3 also show discharge bracket 340, which helps to prevent grass recirculation, and is discussed in greater detail below in connection with FIG. 6. Referring to FIG. 4, illustrated is an example pair of blade tips 322 formed on a mow blade 320 made from a single piece of metal strip stock, according to various embodiments discussed herein. Mow deck 100 can comprise three mow spindles 310, each of which can be aligned with one of the openings 130 shown in FIGS. 1 and 2. Each mow spindle 310 can have a plurality of mow blades 320 (each comprising one or more blade tips 322) mounted on that mow spindle 310. In one example embodiment, each mow blade 320 mounted on a given spindle 310 can be formed from a stamped metal bar (e.g., steel strip stock, etc.), each of which can comprise a blade tip 322 on each end (e.g., with relatively low lift, for example, having a height 326 of a tip of a blade wing raised approximately 1 inch relative to a bottom edge of the blade wing, although other embodiments can employ blade tips with greater or lesser values for height 324 such as 0.75-1.25 inches, etc.), for four blade tips 322 per mow spindle 310. Various shapes of mow blades 320 and blade tips 322 can be employed in various embodiments, with one example embodiment having a blade frontal area 324 (the area of region 324 when projected into a vertical plane, indicated in black) of 1-2 in.² (e.g., 1.1-1.5 in², 1.2-1.4 in², around 1.331 in², etc.). In various embodiments, the two stamped metal bars can be identical mow blades 320 with identical blade tips 322 and stacked vertically, such that one pair of blade tips 322 is one material thickness (e.g., 6 gauge steel strip, which can be around 0.1943″ thick, etc.) higher than the other pair of blade tips 322. In various embodiments, the mow blades 320 for a given spindle can be arranged substantially perpendicular to one another (e.g., at a 90° angle, within ±5°, ±10°, ±15°, ±20°, ±25°, ±30°, etc. of a 90° angle, etc.).

The substantially equally spaced blade tips 322 can be rotated at a lower speed than a maximum allowable (MA) (per the American National Standards Institute (ANSI)) allowed blade speed (19000 feet per minute) speed (e.g., in various embodiments, blade speed can vary based on cutting modes (e.g., side discharge, mulching, or bagging, etc.) and/or performance or grass difficulty modes (e.g., low, medium, or high performance/grass difficulty, etc.), but can be approximately 60-85% of MA, approximately 60-68% of MA for low performance/grass difficulty, approximately 68-76% of MA for medium performance/grass difficulty, and/or approximately 76-85% for high performance/grass difficulty.

Rotational speeds of embodiments discussed herein can also be lower (e.g., thereby providing energy savings, etc.) than the speed(s) of other (e.g., two blade tips, four blade tips grouped into two closely spaced pairs, etc.) lawn maintenance equipment (e.g., operating at 95-98% or greater of maximum), while still providing an approximately 33% improvement in terms of reducing the amount of new grass entering the deck between successive blade tips. Specific example RPM ranges can vary based on deck size and mow blade radius/diameter.

In various embodiments, the substantially equally spaced blade tips can be rotated at a lower RPM, using less energy, while also cutting more efficiently (less new grass per blade tip) than other lawn maintenance equipment. Because the W-baffle 210 can provide for substantially improved grass discharge compared to other mow decks, mow blades 320 can be configured to improve energy and cutting efficiency, and the combination of mow deck 100 and mow blades 320 can provide for improved grass discharge and energy efficiency compared to other mow decks employing blade configurations selected to improve grass discharge (e.g., two blade tips, four blade tips grouped into two closely spaced pairs, etc.).

In some embodiments, different mow spindles can be rotated with different angular velocities, in terms of direction of rotation and/or speed of rotation. For example, for mulching applications, while some mow spindles (e.g., left and right mow spindles in a 3 spindle deck as discussed above, etc.) can rotate at speeds discussed above, one or more mow spindles (e.g., a center spindle, etc.) can rotate its associated blades with a higher speed than discussed above, but which can still be less than other lawn maintenance equipment. In the same or other embodiments, the direction of rotation of a first mow spindle can differ from that of a second mow spindle (e.g., rotating one side spindle in a different direction than the other two in a mode, etc.), which can alter the flow of air and grass clippings under mow deck 100, including the amount of grass clippings exiting mow deck 100 along the W-baffle 210 relative to the amount of grass clippings exiting mow deck 100 via grass discharge 150.

In the example embodiment of FIG. 3, each mow blade 320 can have the same shape and lift, although in some embodiments mow blades can differ from one another. Additionally, while the mow blades 320 shown in FIG. 3 have the shape shown therein for a mow deck 100 with grass discharge 150 (e.g., on the side, top-side, top, etc.), other shapes and/or lift can be employed on the same or other mow decks (e.g., mulching mow deck 800, discussed below, etc.).

Mow blades 320 can be formed from a variety of materials and/or thicknesses. The example embodiment shown in the Figures has mow blades 320 formed from 6 gauge steel strip stock (although greater or lesser thicknesses can be employed), and can be employed in connection with battery-powered lawn maintenance apparatus, providing for a thicker mow blade than on other battery-powered lawn maintenance apparatuses (e.g., some other lawn maintenance apparatuses employ blades with a thickness of around 0.15″, which is approximately the thickness of 9 gauge steel, etc.).

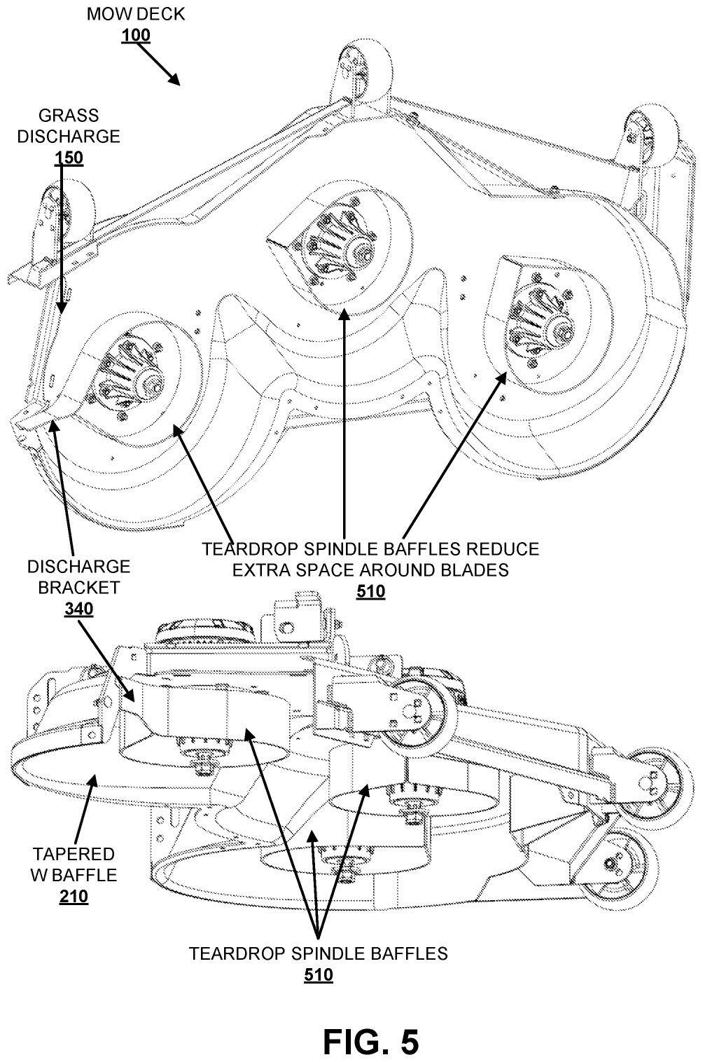

In various embodiments, additional baffling can be employed around the mow spindles, to further reduce extra space inside the mow deck around the mow blades. Different embodiments can employ different shapes of spindle baffles. Referring to FIG. 5, illustrated are a bottom perspective view and a side view of a mow deck 100 employing teardrop shaped spindle baffles 510 around mow spindles 310, according to various embodiments discussed herein. The teardrop spindle baffles 510 reduce extra space around the mow blades 320, improving air flow and mower efficiency. Additionally, teardrop spindle baffles 510 can be shaped to direct air flow (e.g., or flow of air and grass clippings, while in operation, etc.) toward the grass discharge 150 of mow deck 100. In various embodiments, spindle baffles 510 can be rolled inserts with substantially vertical profiles.

Referring to FIG. 6, illustrated are a front diagram (top image) and a bottom diagram (bottom image) of an example embodiment of a mow deck 100, according to various embodiments discussed herein. FIG. 6 shows outer front baffles 610 (which can provide a lower outer surface to mow deck 100, for example, to block obstacles, etc.) and inner front baffles 620 (which can reduce the space under the mow deck, and thus the area from which air is pulled by mow blades 320, thereby increasing efficiency. In various embodiments or portions thereof, the outer front baffle 610 and inner front baffle 620 can be separate (e.g., as shown on the left side of the bottom image of FIG. 6, etc.) or can comprise a single front baffle (e.g., as shown on the right side of the bottom image of FIG. 6, etc.). As shown in the bottom image of FIG. 6, the inner front baffle 620 (or single front baffle, etc.) can be pulled back toward the circles of mow blades 320, reducing the air to be moved under the mow deck 100, improving air flow and efficiency. In some embodiments, the front of mow deck 100 can comprise optional gaps 630, which can help increase airflow into mow deck 100. The clearance between the blade tips 322 of mow blades 320 and the inner front baffle 620 can vary and can be generally greater closer to grass discharge 150. In some embodiments, the clearance at locations 622, 624, 625, and 626 can be similar to each other (e.g., 0.5-1″, 0.7-0.8″, around 0.76″, etc.), while the clearance at location 621 can be smaller (e.g., 0.3-0.7″, 0.4-0.6″, around 0.51″, etc.) and the clearance at location 623 can be greater (e.g., 2-3″, 2.25-2.75″, around 2.575″, etc.). The relatively open space between inner front baffle 620 and mow blades 320, especially closer to grass discharge 150 (e.g., as compared to the relatively closed space between W-baffle 210 and mow blades), allows air and grass clippings to pass from the regions around the farthest mow spindle 310 from grass discharge 150 toward the region in front of the center mow spindle 310, from the region around the center mow spindle 310 toward the region in front of the closest mow spindle 310 to grass discharge 150, and from the region around the closest mow spindle 310 out grass discharge 150.

Various embodiments can also comprise discharge bracket 340, which can be located proximate to grass discharge 150 and extending from grass discharge 150 toward the mow spindle 310 closest to grass discharge 150 (the leftmost mow spindle 310 in the bottom image of FIG. 6; the rightmost mow spindle 310 when viewed from above). When viewed from underneath (as in the bottom image of FIG. 6), the mow blades 320 can rotate counterclockwise, to direct air and grass clippings from the mow spindle 310 furthest from grass discharge 150 (the rightmost mow spindle 310 in the bottom image of FIG. 6; the leftmost mow spindle 310 when viewed from above) to the middle mow spindle 310, and from the middle mow spindle 310 to the mow spindle 310 closest to grass discharge 150. Without discharge bracket 340, a significant portion of air and grass clippings would be recirculated toward the back of the deck around the mow spindle 310 closest to grass discharge 150 one or more times before being discharged via grass discharge 150. By including discharge bracket 340, which blocks a substantial portion of the space above the mow blades 320 on the mow spindle 310 closest to grass discharge 150, a significantly larger portion of both air and grass clippings are directed out grass discharge 150, reducing energy expended on recirculation of the air and grass clippings mixture.

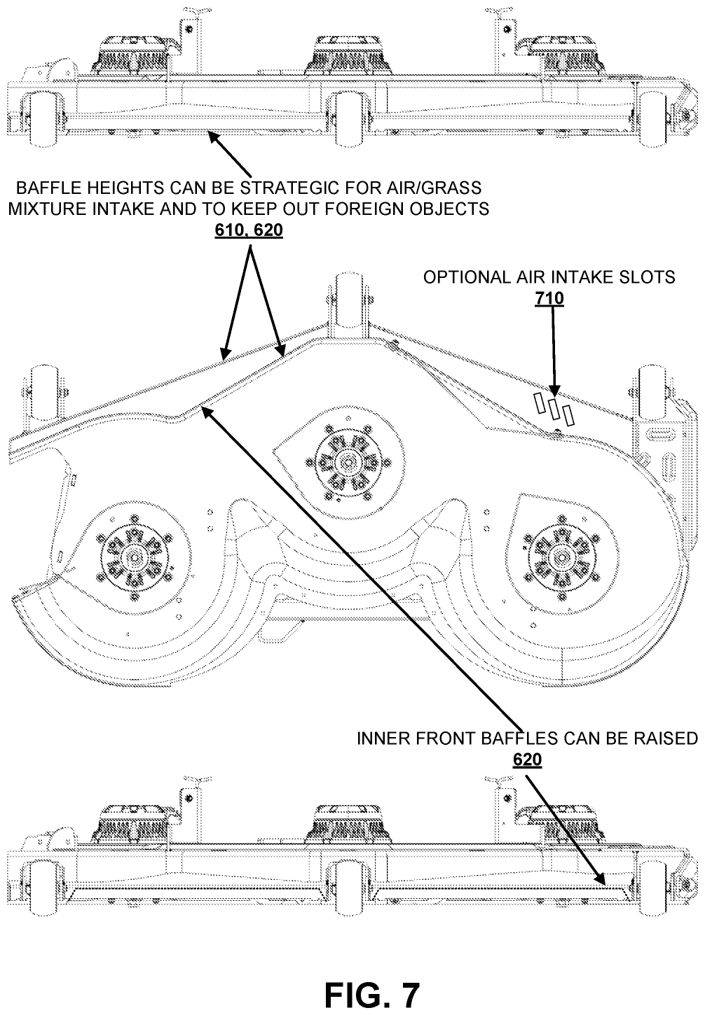

Referring to FIG. 7, illustrated are a first front diagram (top), bottom diagram (middle), and second front diagram (bottom) of an example embodiment of a mow deck 100, according to various embodiments discussed herein. In various embodiments, mow deck 100 can comprise optional air intake slots 710 that can ensure sufficient air flow in mow deck 100 for more efficient cutting. In various embodiments, the heights of front baffles 610 and 620 can vary, with the outer front baffle 610 closer to the ground (e.g., to keep obstacles and foreign objects from entering under mow deck 100, etc.) and the inner front baffle 620 more elevated from the ground to allow sufficient air to mix with grass cut by mow deck 100. The raised height of the inner front baffle 620 also provides a greater discharge distance and performance than alternative embodiments wherein the height of the inner front baffle 620 is lower than or at the same height as the outer front baffle 610.

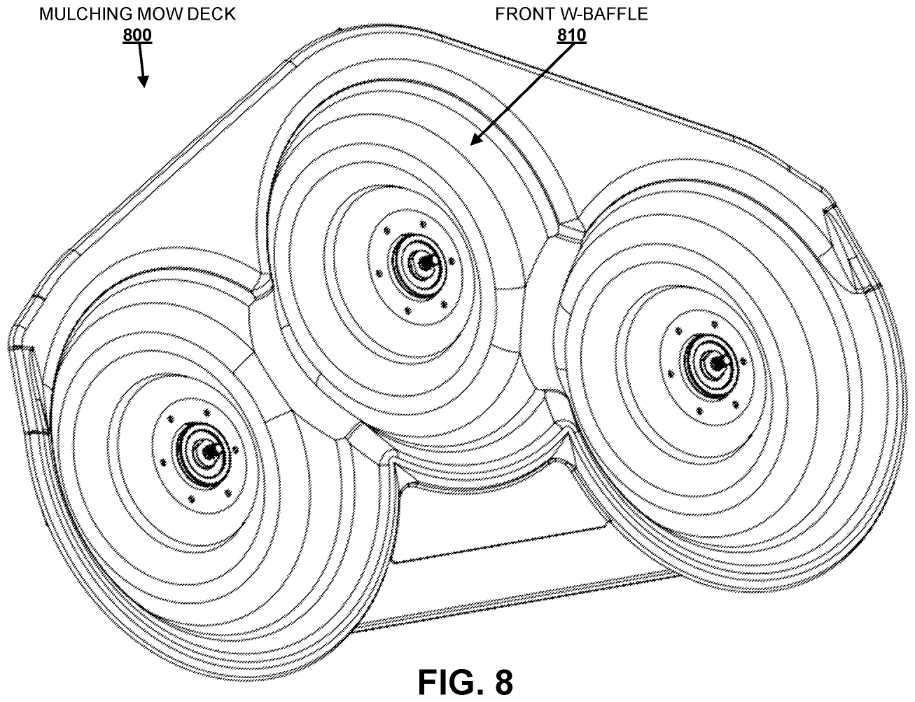

Referring to FIG. 8, illustrated is an example embodiment of a mulching mow deck 800, according to various aspects discussed herein. In contrast with mow deck 100, mulching mow deck 800 can omit (or block with part of a mulch kit to convert mow deck 100 to mow deck 800) a grass discharge 150, to keep air and clippings circulating longer within mulching mow deck 800, allowing clippings to be cut to a smaller size. Additionally, mulching mow deck 800 can have a stamped shape that comprises W-baffle 210 as well as a front W-baffle 810 that follows the shape of mow blades 320 at the front of mulching mow deck 800 similarly to W-baffle 210 does at the rear of mow deck 100 or mulching mow deck 800 (e.g., leaving a small gap at the height of the mow blades 320, curving inward above the mow blades 320 and outward below mow blades 320). In some embodiments, front W-baffle 810 can be part of a mulch kit installable as a separate component to convert another mow deck (e.g., mow deck 100) to mow deck 800. The shape formed by both W-baffle 210 and front W-baffle 810 can reduce unused air space under mulching mow deck 800, keeping air and grass clippings close to mow blades 320 for repeated cutting, while allowing air and grass clippings to be pushed downward eventually after grass clippings are sufficiently cut. In various embodiments, a mulching mow deck 800 can be a separate mow deck or can be formed by combining a mow deck such as mow deck 100 with a mulch kit that can include a mulch plug for blocking grass discharge 150 and one or more baffles that can reduce the space between mow blades and the front of mow deck 100. In some embodiments these front baffles can be vertical, while in others they can have a sloped or curved shape such as shown in FIG. 8 (e.g., comprising front W-baffle 810).

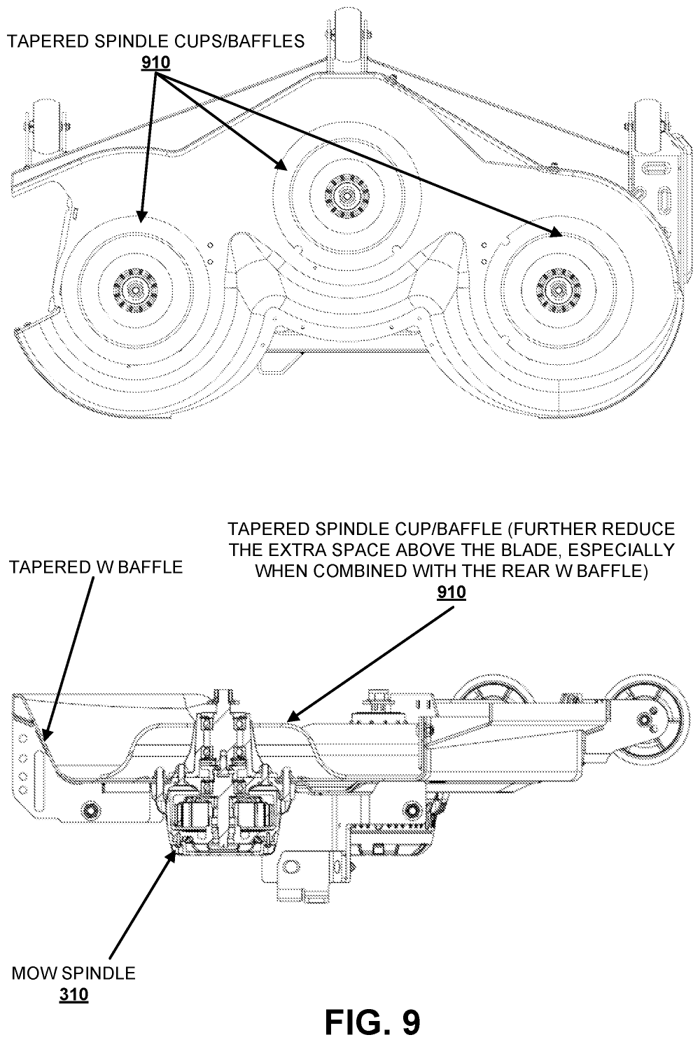

Referring to FIG. 9, illustrated are a bottom view (top image) and a side cross-section view (bottom image) of an example mow deck 100 with tapered spindle cups or baffles 910, according to various embodiments discussed herein. Tapered spindle cups/baffles 910 are another option for baffles that can be included around mow spindles 310 in various embodiments, which can further reduce space above and around the mow blades 320, especially when combined with other baffles (e.g., rear W-baffle 210, front baffle(s), etc.). As shown in the lower image of FIG. 9 (with the top of mow deck 100 at the bottom of the image), tapered spindle cups/baffles 910 can be wider closer to the top of mow deck 100 (e.g., further above mow blades 320) and can narrow as tapered spindle cups/baffles 910 approach mow blades 320.

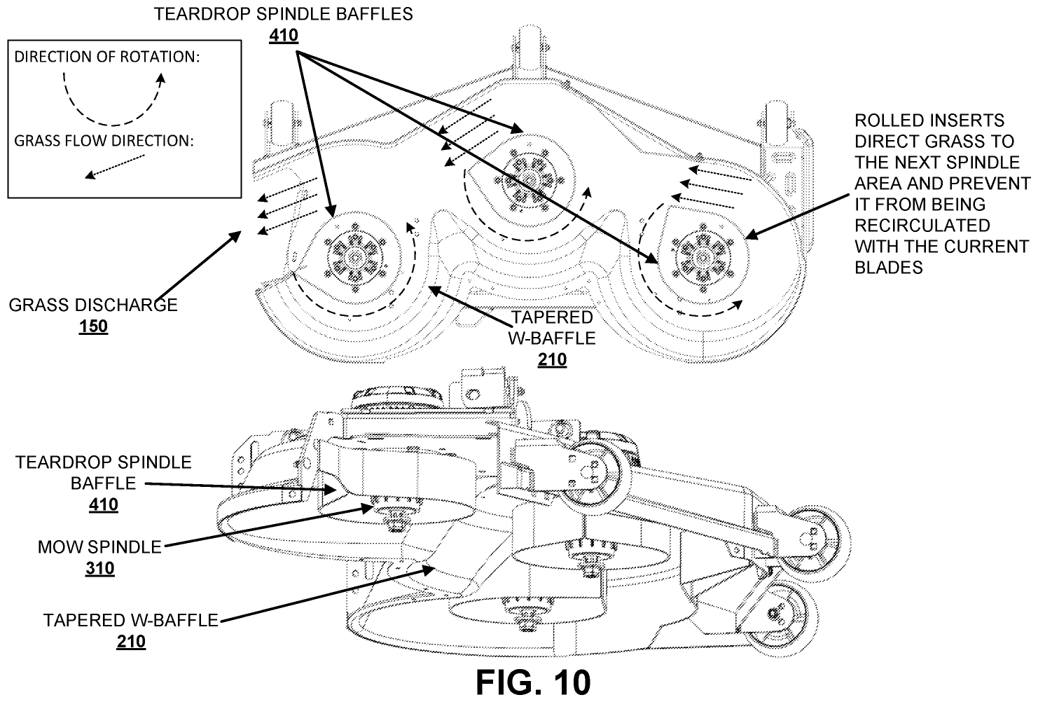

Both teardrop spindle baffles 510 and tapered spindle baffles 910 can reduce the space around mow blades 320, and either can be combined with W-baffle 210 to further reduce that space, increasing efficiency and the flow of air/grass mixture to grass discharge 150. Referring to FIG. 10, illustrated are a bottom view and a side perspective view of an example mow deck 100 comprising teardrop spindle baffles 510, according to various embodiments discussed herein. As seen in the top image of FIG. 10, teardrop spindle baffles 510 can be shaped to point toward grass discharge 150, and the direction of rotation of mow blades 320 and shape of spindle baffles 510 can efficiently direct air and grass clippings out grass discharge 150. In various embodiments (e.g., see FIGS. 5-7 and 10), the spindle baffle 510 closest to grass discharge 150 can comprise a connecting piece that extends from the rolled shape of that baffle 510 to an edge of grass discharge 150, to further direct grass clippings out grass discharge 150. Additionally, while in various embodiments (e.g., as shown in FIGS. 5 and 7) the spindle baffle 510 closest to grass discharge 150 can have a teardrop shape similar to other spindle baffles 510, in other embodiments that spindle baffle 510 can have a more circular profile.

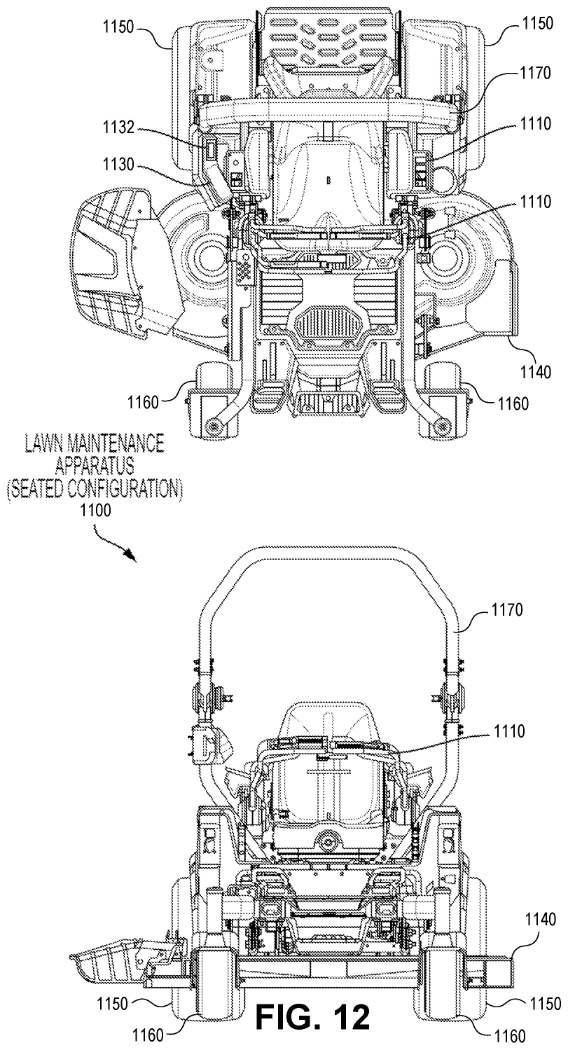

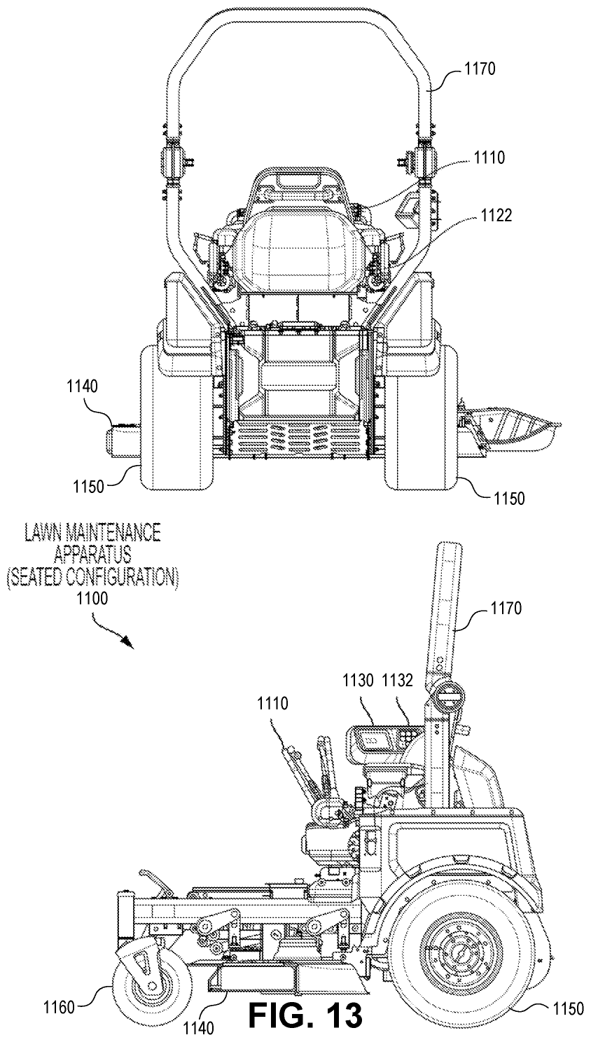

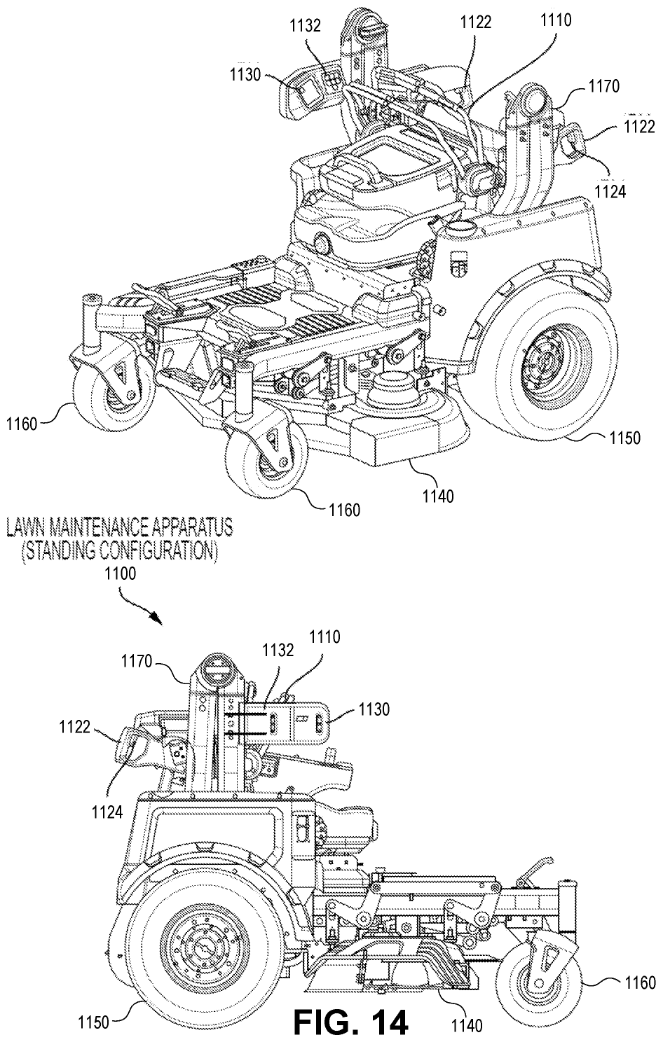

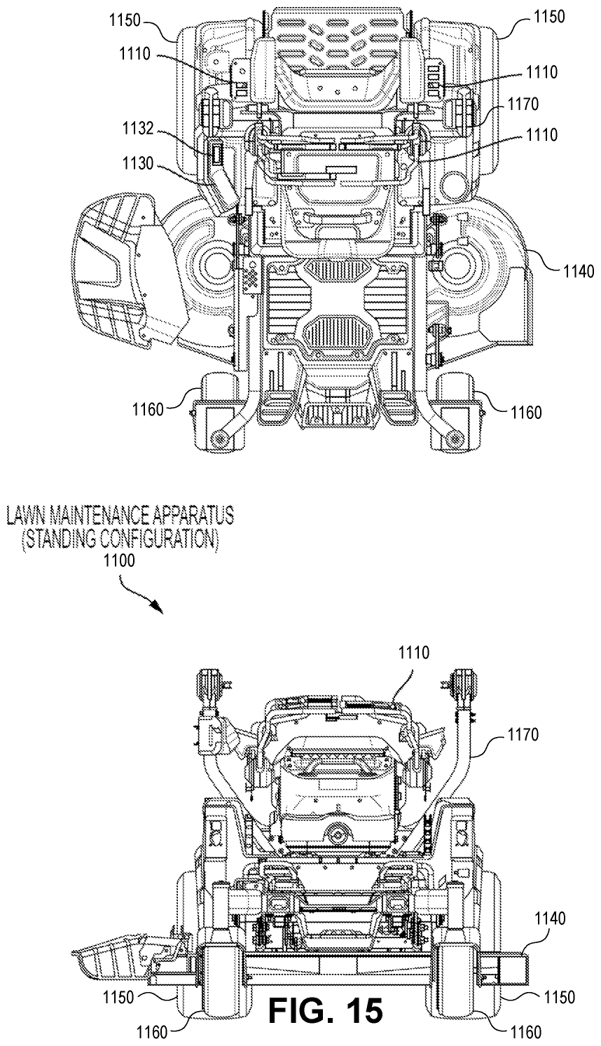

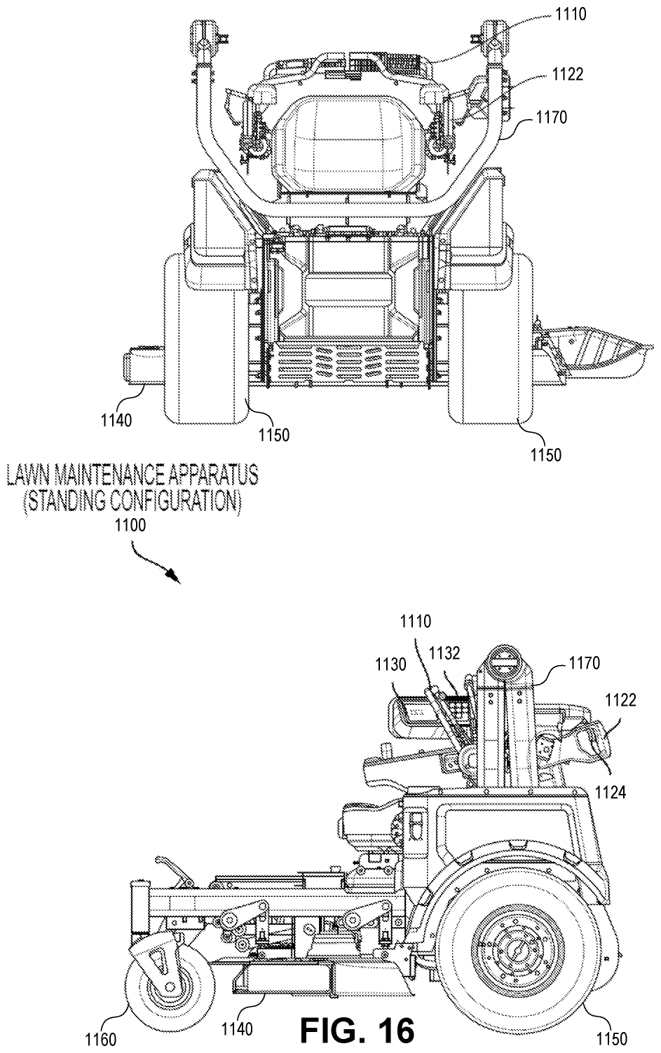

FIGS. 11-16 below illustrate various views of an example embodiment of a convertible seated/standing lawn-maintenance apparatus that can employ a mow deck and/or cutting system according to any of a variety of embodiments discussed herein. FIGS. 11-16 illustrate line images of an example embodiment of a lawn maintenance apparatus 1100 in a seated configuration (FIGS. 11-13) and a standing configuration (FIGS. 14-16). FIG. 11 illustrates left perspective (top) and right (bottom) views of the example embodiment 1100 in the seated configuration, according to various aspects discussed herein. FIG. 12 illustrates top (top) and front (bottom) views of the example embodiment 1100 in the seated configuration, according to various aspects discussed herein. FIG. 13 illustrates rear (top) and left (bottom) views of the example embodiment 1100 in the seated configuration, according to various aspects discussed herein. FIG. 14 illustrates left perspective (top) and right (bottom) views of the example embodiment 1100 in the standing configuration, according to various aspects discussed herein. FIG. 15 illustrates top (top) and front (bottom) views of the example embodiment 1100 in the standing configuration, according to various aspects discussed herein. FIG. 16 illustrates rear (top) and left (bottom) views of the example embodiment 1100 in the standing configuration, according to various aspects discussed herein.

Embodiment 1100 is an example lawn maintenance apparatus that can comprise or employ a mow deck as discussed herein (e.g., mow deck 100, etc.), with exceptions and/or additions as discussed below. Embodiment 1100 can be powered electrically, based on an engine (e.g., gas, diesel, etc.), hybrid, etc. The prime mover (not shown) of embodiment 1100 can power various powered components of embodiment 1100, such as mow deck 1140 and drive wheels 1150. Embodiment 1100 can also comprise one or more non-driven wheels 1160, which can be caster wheels and/or actively steered wheels, etc.

Embodiment 1100 comprises mower controls 1110 (e.g., comprising lap bars, armrest mounted controls, etc.) that can be moved along control mounts 1120 via depressing triggers 1124 on handles 1122 and pushing or pulling the controls 1110 to the seated (forward) or standing (rearward) position where control mount 1120 can be again locked into position. The control adjustment mechanism includes a user handle or grip 1122 along with a trigger or actuator 1124 for adjusting the controls 1110 between standing mode operation in a rearward position and sitting mode operation in a forward position.

Additionally, in embodiment 1100 display screen 1130 and keypad 1132 can be mounted from the rollover protection (ROP) bar 1170, allowing access in both the seated and standing modes of operation.

In regard to the various functions performed by the above described components, machines, devices, processes and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments include a system as well as electronic hardware configured to implement the functions, or a computer-readable medium having computer-executable instructions for performing the acts or events of the various processes.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In other embodiments, combinations or sub-combinations of the above disclosed embodiments can be advantageously made. Moreover, embodiments described in a particular drawing or group of drawings should not be limited to those illustrations. Rather, any suitable combination or subset of elements from one drawing(s) can be applied to other embodiments in other drawings where suitable to one of ordinary skill in the art to accomplish objectives disclosed herein, known in the art, or reasonably conveyed to one of ordinary skill in the art by way of the context provided in this specification. Where utilized, block diagrams of the disclosed embodiments or flow charts are grouped for ease of understanding. However, it should be understood that combinations of blocks, additions of new blocks, re-arrangement of blocks, and the like are contemplated in alternative embodiments of the present disclosure.

The following examples pertain to further embodiments.
Example 1 is a lawn maintenance apparatus, comprising: a frame; a plurality of drive wheels rotatable about a drive wheel rotation axis; at least one of an operator seat or a standing platform secured to the frame; operator controls for operator-initiated functions of the lawn maintenance apparatus; and a mow deck secured to the frame, wherein the mow deck comprises a plurality of mow spindles, wherein each mow spindle of the plurality of mow spindles is configured to drive one or more mow blades, wherein the mow deck comprises at least one baffle that reduces space around the one or more mow blades of at least one of the plurality of mow spindles, and wherein the at least one baffle comprises a W-baffle with a non-vertical cross-section that comprises an associated arc for each mow spindle of the plurality of mow spindles, wherein on each associated arc the W-baffle is a substantially constant distance from an axis of rotation of the mow spindle of that associated arc on a plane of the one or more mow blades of that spindle.
Example 2 comprises the subject matter of any variation of any of example(s) 1, wherein, for each mow spindle of the plurality of mow spindles, the W-baffle is closer than the substantially constant distance to the axis of rotation of that mow spindle above the plane of the one or more mow blades of that mow spindle and is farther than the substantially constant from the axis of rotation of that mow spindle distance below the plane of the one or more mow blades of that mow spindle.
Example 3 comprises the subject matter of any variation of any of example(s) 1-2, wherein the at least one baffle comprises one or more front baffles in front of the plurality of mow spindles.
Example 4 comprises the subject matter of any variation of any of example(s) 3, wherein the one or more front baffles are substantially vertical and comprise one or more straight segments.
Example 5 comprises the subject matter of any variation of any of example(s) 3-4, wherein the one or more front baffles comprise an outer front baffle and an inner front baffle.
Example 6 comprises the subject matter of any variation of any of example(s) 5, wherein the outer front baffle extends downward below a bottom of the inner front baffle.
Example 7 comprises the subject matter of any variation of any of example(s) 1-6, wherein for each mow spindle, the one or more mow blades of that mow spindle comprise two mow blades of that mow spindle, wherein the two mow blades of that mow spindle comprise four blade tips of that mow spindle.
Example 8 comprises the subject matter of any variation of any of example(s) 7, wherein for each mow spindle, the four blade tips of that mow spindle are equally spaced.
Example 9 comprises the subject matter of any variation of any of example(s) 8, wherein for each mow spindle, the four blade tips of that mow spindle of that mow spindle are arranged on ends of the two mow blades of that mow spindle, wherein the two mow blades of that mow spindle are substantially perpendicular to one another.
Example 10 comprises the subject matter of any variation of any of example(s) 7-9, wherein for each mow spindle, the four blade tips of that spindle have the same shape.
Example 11 comprises the subject matter of any variation of any of example(s) 1-10, wherein each mow spindle is configured to rotate with an angular speed between 60-85% of a maximum allowable angular speed.
Example 12 is a lawn maintenance apparatus, comprising: a frame; a plurality of drive wheels rotatable about a drive wheel rotation axis; at least one of an operator seat or a standing platform secured to the frame; operator controls for operator-initiated functions of the lawn maintenance apparatus; and a mow deck secured to the frame, wherein the mow deck comprises a plurality of mow spindles, wherein each mow spindle of the plurality of mow spindles is configured to drive two associated mow blades comprising four equally spaced associated blade tips.
Example 13 comprises the subject matter of any variation of any of example(s) 12, wherein for each mow spindle, the four associated blade tips of that mow spindle are arranged on the two associated mow blades of that spindle, wherein the two associated mow blades of that mow spindle are substantially perpendicular to one another.
Example 14 comprises the subject matter of any variation of any of example(s) 13, wherein for each mow spindle, the two mow blades of that mow spindle are formed from 6 gauge steel strip stock.
Example 15 comprises the subject matter of any variation of any of example(s) 12-14, wherein each mow spindle is configured to rotate with an angular speed between 60-85% of a maximum allowable angular speed.
Example 16 comprises the subject matter of any variation of any of example(s) 15, wherein, for each mow spindle, the angular speed at which that mow spindle is configured to rotate depends on at least one of a cutting mode or a performance mode.
Example 17 comprises the subject matter of any variation of any of example(s) 12-16, wherein for each mow spindle, the four associated blade tips of that spindle have the same shape.
Example 18 comprises the subject matter of any variation of any of example(s) 17, wherein for each mow spindle, each associated blade tip comprises a wing portion that is angled relative to a plane of motion of the associated mow blade comprising that associated blade tip, wherein the wing portion has a frontal area of 1.1-1.5 in².
Example 19 comprises the subject matter of any variation of any of example(s) 12-18, wherein a first mow spindle of the plurality of mow spindles is configured to rotate with a first angular velocity, and wherein a second mow spindle of the plurality of mow spindles is configured to rotate with a second angular velocity that is different from the first angular velocity.
Example 20 comprises the subject matter of any variation of any of example(s) 19, wherein the first angular velocity has a different magnitude than the second angular velocity.
Example 21 comprises the subject matter of any variation of any of example(s) 19-20, wherein the first angular velocity has a different direction than the second angular velocity.
Example 22 comprises the subject matter of any variation of any of example(s) 19-21, further comprising at least one battery configured to provide power to the plurality of drive wheels and the plurality of mow spindles.
Example 23 is a mow deck for a lawn maintenance apparatus, comprising: a bottom portion formed from a first single stamped sheet of material, wherein the bottom portion comprises a first plurality of spindle holes, wherein each spindle hole of the first plurality of spindle holes is shaped to accommodate an associated mow spindle of a plurality of mow spindles, wherein the bottom portion comprises at least one baffle configured to reduce space around one or more mow blades of the plurality of mow spindles; and a top portion formed from a second single stamped sheet of material, wherein the top portion comprises a second plurality of spindle holes configured to align with the first plurality of spindle holes, wherein each spindle hole of the second plurality of spindle holes is shaped to accommodate an associated mow spindle of the plurality of mow spindles, wherein the top portion comprises one or more embossed regions that are raised relative to one or more unembossed regions of the top portion, and wherein the one or more embossed regions of the top portion act as stiffening features to at least one of prevent or mitigate deformation of the mow deck.
Example 24 comprises the subject matter of any variation of any of example(s) 23, wherein the top portion is welded to the bottom portion.
Example 25 comprises the subject matter of any variation of any of example(s) 23-24, wherein the at least one baffle comprises a W-baffle with a non-vertical cross-section that comprises an associated arc for each spindle hole of the first plurality of spindle holes, wherein on each associated arc, the distance from a center of the spindle hole of that associated arc is substantially constant for each point on that associated arc at a given height.
Example 26 comprises the subject matter of any variation of any of example(s) 25, wherein on each associated arc, the distance from the center of the spindle hole of that associated arc decreases with height.
Example 27 comprises the subject matter of any variation of any of example(s) 23-26, wherein the at least one baffle comprises one or more substantially vertical front baffles.
Example 28 comprises the subject matter of any variation of any of example(s) 23-27, wherein the first plurality of spindle holes comprises three spindle holes arranged in a triangle with a center spindle hole of the three spindle holes in front of the other two spindle holes of the three spindle holes.
Example 29 is a method of fabricating a mow deck for a lawn maintenance apparatus, comprising: stamping a first single sheet of material to form a bottom portion of the mow deck, wherein the bottom portion comprises at least one baffle configured to reduce space around one or more mow blades of the plurality of mow spindles; cutting a first plurality of holes in the bottom portion, wherein the first plurality of holes comprises a first plurality of spindle holes, wherein each spindle hole of the first plurality of spindle holes is shaped to accommodate an associated mow spindle of a plurality of mow spindles, stamping a second single sheet of material to form a top portion of the mow deck, wherein the top portion comprises one or more embossed regions that are raised relative to one or more unembossed regions of the top portion, and wherein the one or more embossed regions of the top portion act as stiffening features to at least one of prevent or mitigate deformation of the mow deck; cutting a second plurality of holes in the top portion, wherein the second plurality of holes comprises a second plurality of spindle holes configured to align with the first plurality of spindle holes, wherein each spindle hole of the second plurality of spindle holes is shaped to accommodate an associated mow spindle of the plurality of mow spindles; and welding the top portion to the bottom portion at a plurality of welding locations.
Example 30 comprises the subject matter of any variation of any of example(s) 29, wherein the plurality of welding locations comprise a plurality of locations along an outer edge of the top portion.
Example 31 comprises the subject matter of any variation of any of example(s) 29-30, wherein the second plurality of holes comprises a plurality of welding holes, and wherein the plurality of welding locations comprise the plurality of welding holes.
Example 32 comprises the subject matter of any variation of any of example(s) 29-31, wherein the at least one baffle comprises a W-baffle with a non-vertical cross-section that comprises an associated arc for each spindle hole of the first plurality of spindle holes, wherein on each associated arc, the distance from a center of the spindle hole of that associated arc is substantially constant for each point on that associated arc at a given height.
Example 33 comprises the subject matter of any variation of any of example(s) 32, wherein on each associated arc, the distance from the center of the spindle hole of that associated arc decreases with height.
Example 34 comprises the subject matter of any variation of any of example(s) 29-33, wherein the at least one baffle comprises one or more substantially vertical front baffles.
Example 35 comprises the subject matter of any variation of any of example(s) 29-34, wherein the first plurality of spindle holes comprises three spindle holes arranged in a triangle with a center spindle hole of the three spindle holes in front of the other two spindle holes of the three spindle holes.
Example 36 comprises the subject matter of any variation of any of example(s) 29-35, wherein cutting the first plurality of holes in the bottom portion comprises cutting the first plurality of holes with a laser, and wherein cutting the second plurality of holes in the top portion comprises cutting the second plurality of holes with a laser.

Based on the foregoing it should be understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A lawn maintenance apparatus, comprising:
a frame;
a plurality of drive wheels rotatable about a drive wheel rotation axis;
at least one of an operator seat or a standing platform secured to the frame;
operator controls for operator-initiated functions of the lawn maintenance apparatus; and
a mow deck secured to the frame, wherein the mow deck comprises a plurality of mow spindles, wherein each mow spindle of the plurality of mow spindles is configured to drive one or more mow blades,
wherein the mow deck comprises at least one baffle that reduces space around the one or more mow blades of at least one of the plurality of mow spindles, and
wherein the at least one baffle comprises a W-baffle with a non-vertical cross-section that comprises an associated arc for each mow spindle of the plurality of mow spindles, wherein on each associated arc the W-baffle is a substantially constant distance from an axis of rotation of the mow spindle of that associated arc on a plane of the one or more mow blades of that spindle.

2. The lawn maintenance apparatus of claim 1, wherein, for each mow spindle of the plurality of mow spindles, the W-baffle is closer than the substantially constant distance to the axis of rotation of that mow spindle above the plane of the one or more mow blades of that mow spindle and is farther than the substantially constant from the axis of rotation of that mow spindle distance below the plane of the one or more mow blades of that mow spindle.

3. The lawn maintenance apparatus of claim 1, wherein the at least one baffle comprises one or more front baffles in front of the plurality of mow spindles.

4. The lawn maintenance apparatus of claim 3, wherein the one or more front baffles are substantially vertical and comprise one or more straight segments.

5. The lawn maintenance apparatus of claim 3, wherein the one or more front baffles comprise an outer front baffle and an inner front baffle.

6. The lawn maintenance apparatus of claim 5, wherein the outer front baffle extends downward below a bottom of the inner front baffle.

7. The lawn maintenance apparatus of claim 1, wherein for each mow spindle, the one or more mow blades of that mow spindle comprise two mow blades of that mow spindle, wherein the two mow blades of that mow spindle comprise four blade tips of that mow spindle.

8. The lawn maintenance apparatus of claim 7, wherein for each mow spindle, the four blade tips of that mow spindle are equally spaced.

9. The lawn maintenance apparatus of claim 8, wherein for each mow spindle, the four blade tips of that mow spindle of that mow spindle are arranged on ends of the two mow blades of that mow spindle, wherein the two mow blades of that mow spindle are substantially perpendicular to one another.

10. The lawn maintenance apparatus of claim 7, wherein for each mow spindle, the four blade tips of that spindle have the same shape.

11. The lawn maintenance apparatus of claim 1, wherein each mow spindle is configured to rotate with an angular speed between 60-85% of a maximum allowable angular speed.

12. A lawn maintenance apparatus, comprising:
a frame;
a plurality of drive wheels rotatable about a drive wheel rotation axis;
at least one of an operator seat or a standing platform secured to the frame;
operator controls for operator-initiated functions of the lawn maintenance apparatus; and
a mow deck secured to the frame, wherein the mow deck comprises a plurality of mow spindles, wherein each mow spindle of the plurality of mow spindles is configured to drive two associated mow blades comprising four equally spaced associated blade tips.

13. The lawn maintenance apparatus of claim 12, wherein for each mow spindle, the four associated blade tips of that mow spindle are arranged on the two associated mow blades of that spindle, wherein the two associated mow blades of that mow spindle are substantially perpendicular to one another.

14. The lawn maintenance apparatus of claim 13, wherein for each mow spindle, the two mow blades of that mow spindle are formed from 6 gauge steel strip stock.

15. The lawn maintenance apparatus of claim 12, wherein each mow spindle is configured to rotate with an angular speed between 60-85% of a maximum allowable angular speed.

16. The lawn maintenance apparatus of claim 15, wherein, for each mow spindle, the angular speed at which that mow spindle is configured to rotate depends on at least one of a cutting mode or a performance mode.

17. The lawn maintenance apparatus of claim 12, wherein for each mow spindle, the four associated blade tips of that spindle have the same shape.

18. The lawn maintenance apparatus of claim 17, wherein for each mow spindle, each associated blade tip comprises a wing portion that is angled relative to a plane of motion of the associated mow blade comprising that associated blade tip, wherein the wing portion has a frontal area of 1.1-1.5 in².

19. The lawn maintenance apparatus of claim 12, wherein a first mow spindle of the plurality of mow spindles is configured to rotate with a first angular velocity, and wherein a second mow spindle of the plurality of mow spindles is configured to rotate with a second angular velocity that is different from the first angular velocity.

20. The lawn maintenance apparatus of claim 19, wherein the first angular velocity has a different magnitude than the second angular velocity.

21. The lawn maintenance apparatus of claim 19, wherein the first angular velocity has a different direction than the second angular velocity.

22. The lawn maintenance apparatus of claim 19, further comprising at least one battery configured to provide power to the plurality of drive wheels and the plurality of mow spindles.

23. A mow deck for a lawn maintenance apparatus, comprising:
a bottom portion formed from a first single stamped sheet of material, wherein the bottom portion comprises a first plurality of spindle holes, wherein each spindle hole of the first plurality of spindle holes is shaped to accommodate an associated mow spindle of a plurality of mow spindles, wherein the bottom portion comprises at least one baffle configured to reduce space around one or more mow blades of the plurality of mow spindles; and
a top portion formed from a second single stamped sheet of material, wherein the top portion comprises a second plurality of spindle holes configured to align with the first plurality of spindle holes, wherein each spindle hole of the second plurality of spindle holes is shaped to accommodate an associated mow spindle of the plurality of mow spindles, wherein the top portion comprises one or more embossed regions that are raised relative to one or more unembossed regions of the top portion, and wherein the one or more embossed regions of the top portion act as stiffening features to at least one of prevent or mitigate deformation of the mow deck.

24. The mow deck of claim 23, wherein the top portion is welded to the bottom portion.

25. The mow deck of claim 23, wherein the at least one baffle comprises a W-baffle with a non-vertical cross-section that comprises an associated arc for each spindle hole of the first plurality of spindle holes, wherein on each associated arc, the distance from a center of the spindle hole of that associated arc is substantially constant for each point on that associated arc at a given height.

26. The mow deck of claim 25, wherein on each associated arc, the distance from the center of the spindle hole of that associated arc decreases with height.

27. The mow deck of claim 23, wherein the at least one baffle comprises one or more substantially vertical front baffles.

28. The mow deck of claim 23, wherein the first plurality of spindle holes comprises three spindle holes arranged in a triangle with a center spindle hole of the three spindle holes in front of the other two spindle holes of the three spindle holes.

29. A method of fabricating a mow deck for a lawn maintenance apparatus, comprising:
stamping a first single sheet of material to form a bottom portion of the mow deck, wherein the bottom portion comprises at least one baffle configured to reduce space around one or more mow blades of the plurality of mow spindles;
cutting a first plurality of holes in the bottom portion, wherein the first plurality of holes comprises a first plurality of spindle holes, wherein each spindle hole of the first plurality of spindle holes is shaped to accommodate an associated mow spindle of a plurality of mow spindles,
stamping a second single sheet of material to form a top portion of the mow deck, wherein the top portion comprises one or more embossed regions that are raised relative to one or more unembossed regions of the top portion, and wherein the one or more embossed regions of the top portion act as stiffening features to at least one of prevent or mitigate deformation of the mow deck;
cutting a second plurality of holes in the top portion, wherein the second plurality of holes comprises a second plurality of spindle holes configured to align with the first plurality of spindle holes, wherein each spindle hole of the second plurality of spindle holes is shaped to accommodate an associated mow spindle of the plurality of mow spindles; and
welding the top portion to the bottom portion at a plurality of welding locations.

30. The method of claim 29, wherein the plurality of welding locations comprise a plurality of locations along an outer edge of the top portion.

31. The method of claim 29, wherein the second plurality of holes comprises a plurality of welding holes, and wherein the plurality of welding locations comprise the plurality of welding holes.

32. The method of claim 29, wherein the at least one baffle comprises a W-baffle with a non-vertical cross-section that comprises an associated arc for each spindle hole of the first plurality of spindle holes, wherein on each associated arc, the distance from a center of the spindle hole of that associated arc is substantially constant for each point on that associated arc at a given height.

33. The method of claim 32, wherein on each associated arc, the distance from the center of the spindle hole of that associated arc decreases with height.

34. The method of claim 29, wherein the at least one baffle comprises one or more substantially vertical front baffles.

35. The method of claim 29, wherein the first plurality of spindle holes comprises three spindle holes arranged in a triangle with a center spindle hole of the three spindle holes in front of the other two spindle holes of the three spindle holes.

36. The method of claim 29, wherein cutting the first plurality of holes in the bottom portion comprises cutting the first plurality of holes with a laser, and wherein cutting the second plurality of holes in the top portion comprises cutting the second plurality of holes with a laser.
